(19) United States
(12) Patent Application Publication
(10) Pub. No.: US 2012/0216845 A1
(43) Pub. Date: Aug. 30, 2012

(54) HAY BALE HUNTING BLIND

(76) Inventor: Timothy P. Noll, Cross Plains, WI (US)

(21) Appl. No.: 13/034,276

(22) Filed: Feb. 24, 2011

(51) Int. Cl. E04H 15/36; B23P 11/00

(52) U.S. Cl. 135/124; 29/428

(57) ABSTRACT

In various exemplary embodiments, the present disclosure, addresses a hunting blind with the appearance of a hay bale having a frame comprising a plurality of and a covering with an fibrous outer surface having the appearance of baled hay, straw, or similar agricultural material. The frame components are preferably connectable by hand without the use of tools. In some exemplary embodiments, the present disclosure relates to a hay bale hunting blind that is relatively easy to assemble, disassemble, and transport through the use of detachably connectable frame components that are preferably easy to connect and disconnect by hand without the use of tools.

### BACKGROUND

1. Field of the Invention

The present disclosure is related to the field of blinds (e.g., hunting blinds) and other camouflaging devices.

2. Related Art

Hunting blinds help hunters immerse themselves into the local environment of wildlife by, for example, helping hide the hunter from a field of view of an animal to limit the amount of fear or suspicion experienced by that animal. In general, hunting blinds may help obscure, alter, mask, or hide the visual appearance, heat, sound, and/or smell of the hunter. Additionally, blinds and the like may be used by non-hunters to, for example, help a bird watcher get closer to a flock of birds without startling the birds, or help a nature photographer approach or be approached by animals in their natural environment.

Traditional hunting blinds are often camouflaged to look like or otherwise blend into a part of the local environment. For example, traditional hunting blinds may be decorated or adorned with a fabric pattern that looks like a collection of sticks and/or leaves. These patterns help hide (e.g., obscure) any edges and/or sharp angles of the camouflaged object that may be used to differentiate the object from natural objects of the local environment.

Hunting blinds may also help hide, trap, or obscure smells, sounds, heat, or other identifiers from an animal. Likewise, hunting blinds may provide protection to a hunter. For example, hunting blinds may help shelter a hunter from weather (e.g., wind, rain, uncomfortable temperatures, solar exposure, etc.) and/or may protect the hunter from being harmed by animals (e.g., by avoiding recognition by the animals and/or by providing a barrier between the hunter and the animals).

### OUTLINE OF BASIC AND OTHER ADVANTAGEOUS FEATURES

It would be desirable to provide a portable hay bale hunting blind or the like of a type disclosed in the present application that includes any one or more of these or other advantageous features:
A hay bale hunting blind that is portable for relatively easy transportation from one hunting site to another;
A hay bale hunting blind that can be relatively quickly assembled and disassembled;
A hay bale hunting blind that can be assembled and disassembled without the use of any tools;
A hay bale hunting blind that is durable to withstand repeated assembly and disassembly;
A hay bale hunting blind that is stored in a single container for convenient transportation and/or storage;
A hay bale hunting blind with telescoping components to reduce space requirements during transportation and/or storage;
A hay bale hunting blind that is durable, but light-weight for easier handling and transportation;
A hay bale hunting blind with an outer straw surface that is durable;
A hay bale hunting blind with an interior surface that is less flammable than straw; and
A hay bale hunting blind with an interior surface that is non-flammable or flame resistant.

These and other features and advantages of various embodiments of systems and methods according to this invention are described in, or are apparent from, the following detailed description of various exemplary embodiments of various devices, structures, and/or methods according to this invention.

### SUMMARY

An exemplary embodiment relates to a portable hay bale hunting blind comprising a frame comprising a plurality of frame members, the frame members comprising at least two arcuate frame assemblies, comprising a base with a generally flat section and a plurality of detachably connectable segments forming a generally arcuate frame detachably connectable to the base, and a plurality of crossbars detachably connectable to the at least two arcuate frame assemblies wherein the crossbars are detachably connectable to the end assemblies at points interspaced along the generally arcuate frame assemblies; one or more straw covers detachably connectable to the frame comprising a subsurface backing layer, a fibrous layer attached to the base layer, and a netting layer overlaying the fibrous layer wherein the straw cover is detachably connected to the frame.

Another exemplary embodiment relates to a method for tool-free assembly of a portable hay bale hunting blind comprising assembling a frame with a plurality of detachably connectable frame members, comprising a plurality of generally arcuate frame members comprising a plurality of detachably connectable segments and one or more crossbars connecting arcuate frame members; and detachably attaching to the frame one or more straw coverings, comprising a subsurface base layer, a fibrous layer attached to the base layer, and a netting layer overlaying the fibrous layer.

An exemplary embodiment relates to a hay bale hunting blind, comprising a frame comprising a generally rectangular base, two end sections supported by the base and located at a first end and a second end of the base wherein the first end and second end are not adjacent to each other, and one or more crossbeams extending between the end sections; a wire grid extending from a first side of the base to a second side of the base in a generally arcuate shape wherein the first side and second side are not adjacent to each other; and at least one straw covering forming the outer surface of the hunting blind.

Another exemplary embodiment relates to a method of assembling a hunting blind, comprising assembling a frame, comprising a generally rectangular frame base, one or more non-horizontal frame members, and one or more generally horizontal crossbeams between non-horizontal frame members; attaching a generally arcuate shaped grid to the frame; and covering the frame and grid with a straw covering.

These and other features and advantages of various embodiments of systems and methods according to this invention are described in, or are apparent from, the following detailed description of various exemplary embodiments of various devices, structures, and/or methods according to this invention.

### BRIEF DESCRIPTION OF THE DRAWINGS

Various exemplary embodiments of the systems and methods according to the present disclosure will be described in detail, with reference to the following figures, wherein:

FIG. 1 is a cut-out perspective view of an exemplary embodiment of a portable hay bale hunting blind according to the present disclosure;

FIG. 2 is a partial perspective view showing a lower portion of the frame of the embodiment of FIG. 1;

FIG. 3 is an exploded perspective view of an exemplary embodiment of an end portion of the frame of the embodiment of FIG. 1;

FIG. 4 is a partial cross-sectional view of two frame components connected by a shock-cord according to the present disclosure;

FIG. 5 is a close-up exploded view of a first exemplary coupling between frame members of the embodiment of FIG. 2;

FIG. 6 is a perspective, view of the embodiment of FIG. 4 with exemplary embodiments of telescoping vertical support members for a frame for a portable hay bale hunting blind according to the present disclosure;

FIG. 7 is a perspective view of a partially assembled frame according to the embodiment of FIG. 1 illustrating the attachment of a first embodiment of a horizontal frame member according to the present disclosure;

FIG. 8 is a perspective view of a partially assembled frame according to the embodiment of FIG. 1 illustrating the attachment of a second embodiment of a horizontal frame member according to the present disclosure;

FIG. 9 is a close-up partial perspective view of a second exemplary embodiment of a coupling between frame members according to the embodiment of FIG. 7;

FIG. 10 is a perspective view of a frame according to the embodiment of FIG. 1 showing an exemplary embodiment of window covers attaching to the frame according to the present disclosure;

FIG. 11 is a perspective view of a frame according to the embodiment of FIG. 9 and an exemplary embodiment of an end cover being attached thereto according to the present disclosure; and

FIG. 12 is a perspective embodiment of the portable hay bale hunting blind of FIG. 1.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION OF EXEMPLARY EMBODIMENTS

It should be appreciated that the following description of a hunting blind is in relation to use by a hunter for hunting animals. However, any individual could use the described blind for any desired purpose. As such, the following description (e.g., with regard to use by hunters) should be appreciated to include use by any user(s) who may use the blind for any desired purpose.

While traditional hunting blinds may help obscure the edges and/or angles of the blind and/or the hunter, traditional hunting blinds may still appear to be foreign or suspicious objects and may be avoided by animals. For example, a traditional hunting blind may not be specifically recognized as a threat by an animal, however, that animal may still recognize that the hunting blind is not a natural and/or expected object (e.g., a tree) and may still avoid the hunting blind.

Additionally, many traditional hunting blinds (e.g., so-called tree stands or blinds) require natural objects of similar shape and/or size to the object being camouflaged in order for the hunting blind to appear as part of that environment. Likewise, traditional camouflaged blinds require certain foliage, trees, branches, and/or the like to be able to appear as part of the local environment. These traditional hunting blinds may be predominantly useful in wooded areas where the traditional hunting blind may be camouflaged as part of the trees or undergrowth.

However, hunters often hunt in locations or environments that are without large natural objects, such as trees, and/or without substantial foliage (e.g., background foliage). For example, hunters may utilize a feed field or food plot, in which vegetation (e.g., corn, sorghum, winter wheat, rye, triticale, alfalfa, clover, soybeans, brassicas, etc.) is planted that is particularly preferred by a desired animal (e.g., deer or turkey). In such feed fields or food plots, there may not be sufficient natural objects, foliage, or the like to optimally blend into using traditional camouflaged hunting blinds.

However, bales (e.g., hay or straw) are common appearances in fields of many types, including feed fields, food plots, and the like. Animals appear to show little or no fear or suspicion when approaching hay bales (i.e., bales of any hay or straw-like material), perhaps because the animals have become conditioned to seeing hay bales in fields. Additionally, some animals may have become conditioned to the tendency for hay bales to appear and disappear rapidly. For example, a field may be clear one day and include several hay bales the next or vice versa. The abrupt appearance and/or disappearance of these hay bales does not appear to be feared by animals or raise their suspicions. It should be appreciated that, in general, animals are often fearful or otherwise cautious around objects that appear foreign to a local known environment, either by shape and design or by abrupt appearance.

Earlier attempts to make a hay bale style hunting blind have not been successful for several reasons. Earlier hay bale blinds have been too heavy, too permanent, too expensive, and/or required frequent repair and/or replacement. For example, earlier hay bale blinds have used solid steel bars in large dimensions, welded frames, and elaborate assembly. These blinds often require full frame preconstruction and thus create challenges related to shipping (e.g., by requiring freight shipping) and placement in the field. Once assembled, these earlier hay bale blinds are difficult to disassemble and/or move.

Likewise, earlier hay bale blinds have typically used a layer of straw between two layers of fencing and a plastic interior layer to provide a camouflaged outer surface. The straw in these earlier hay bale blinds is not securely fastened to the blind and, as such, is rapidly lost from the blind due, at least in part, to weather conditions and natural settling. That is, the straw layer of previous blinds may be lost due to wind, rainfall, and/or natural settling of the material due to gravity. Many prior hay bale blinds require replacement or significant maintenance every year. The straw layer used in these previous blinds may also be particularly prone to igniting or catching fire in the presence of an ignition source such as, for example, a gas (e.g., propane or natural gas) or electric space heater.

By replacing the straw layer with a more resilient fibrous material, the life of the blind can be extended. The replacement fibrous material may also be less prone to igniting or catching fire than the previous straw layer. Likewise, by improving the construction of the blind, the blind can be made lighter yet strong, while being more efficient to ship, transport, assemble, and/or disassemble.

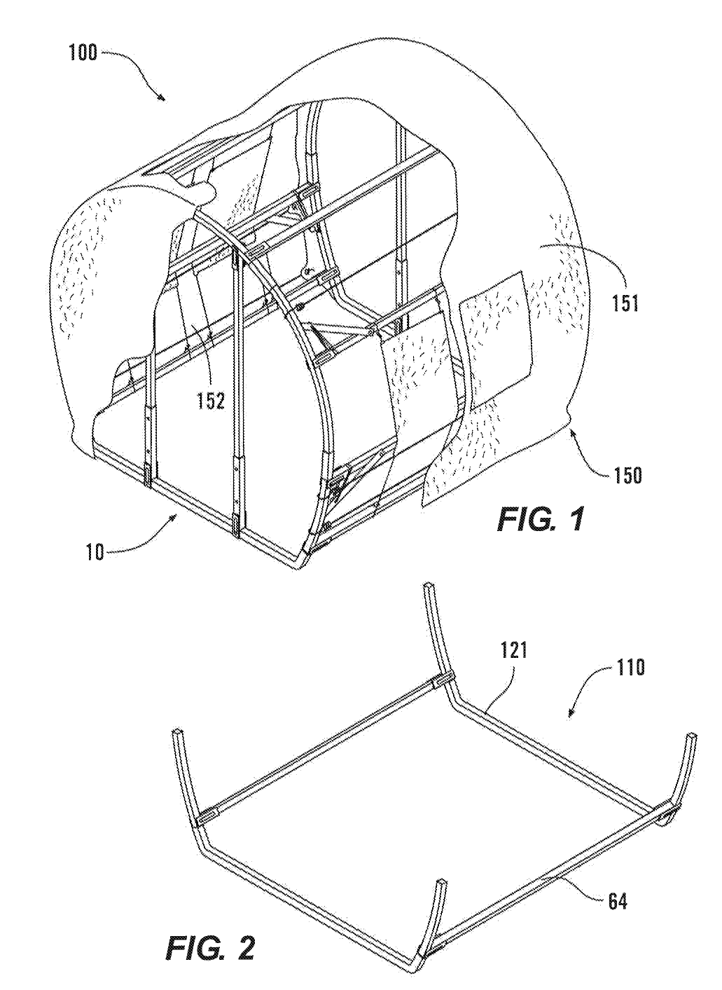

As shown in FIG. 1, in various exemplary embodiments, the present disclosure relates to a portable hay bale blind 100 that has a generally cylindrical shape with roughly circular end portions (e.g., a generally arcuate shape on the top and sides and flat on the bottom). That is, in various exemplary embodiments, hunting blind 100 has a generally circular shaped cross-section in a latitudinal direction and a generally rectangular shaped cross section in a longitudinal direction. Additionally, hunting blind 100 is covered with a material that has the appearance of baled hay or straw.

In various exemplary embodiments, the hay bale blind 100 comprises a frame 110 and a cover 150, which cover 150 may have one or more piece or sections. In various exemplary embodiments, the cover 150 comprises a backing material onto which a fibrous layer 151 is attached. In various exemplary embodiments, the backing material used in top cover of the hay bale blind is waterproof or water resistant and the backing material used to cover the ends is more porous to allow air to pass through and improve ventilation. In various exemplary embodiments, the fibrous covering is made from a material and/or is treated (e.g., with a material or chemical) that is fire-resistant and/or fire-retarding. In various other exemplary embodiments, the end portions of the blind may be covered by another materials, such as, for example, canvas, that is treated (e.g., painted) to resemble the end of a bale.

In general, fibrous covering may give the appearance of rolled or bundled straw or hay and may include bale netting, string, or other bundling material found in hay bales. In various exemplary embodiments, fibrous covering includes end portions that may be used for covering the roughly circular end portions of hunting blind.

In various exemplary embodiments, fibrous covering is an erosion control blanket, which may include coconut fiber and/or straw with a capture net. Erosion control blankets are produced commercially in different grades, which vary in their durability. In preferred embodiments, a longer-wearing material is preferred as it will have to be replaced less frequently. The fibrous covering may comprise natural fibers, processed fibers, and/or synthetic fibers.

In addition to the fibrous layer, additional camouflage material may be added on the exterior of the blind. The camouflage layer may comprise natural materials such as, for example, hay, straw, or corn stalks, and/or artificial materials designed to mimic the appearance of natural materials.

In various exemplary embodiments, the cover 150 is assembled by bonding a fibrous layer 151 (e.g., an erosion control blanket or straw blanket) onto a backing layer. The materials may be bonded by any appropriate method (e.g., adhesives, epoxies, stitching). In various exemplary embodiments, the edges of the two layers are further secured together with stitching and other accessories (e.g., grommets, tie strings, etc.) are attached. In various exemplary embodiments, a netting layer (e.g., polypropylene strands) may be placed over the outermost layer(s) and stitched to the backing to better hold the cover layers in place.

FIG. 2 shows a lower portion of an exemplary embodiment of a frame 110 according to the present disclosure. In various exemplary embodiments, a base piece 121 has a relatively long, straight section that forms the base of the frame 110 (e.g., the part of the frame that rests on the ground). In the embodiment shown, the base pieces 121 are upturned at their ends for engagement with additional components (discussed in greater detail below). According to various exemplary embodiments, the base pieces 121 are connected by two horizontal crossbars 111 at or near ground level.

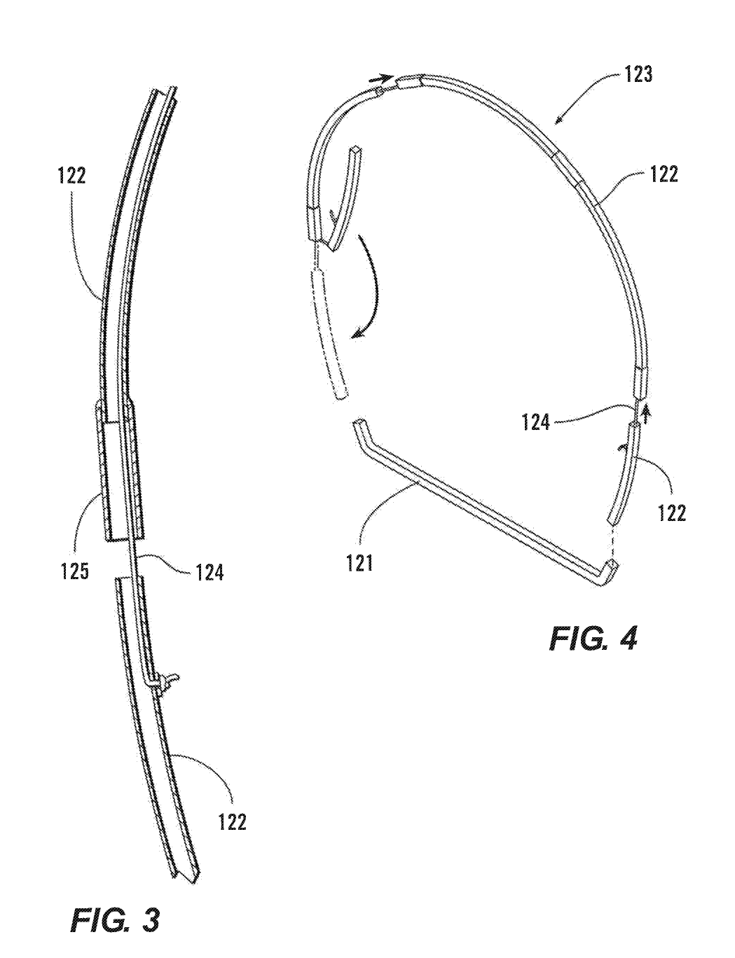

FIGS. 3 and 4 show an exemplary embodiment of an arcuate frame assembly 120. In various exemplary embodiments, an arcuate frame assembly 120 is formed from the base 121 and a plurality of segments 122 that combine to form a generally arcuate frame section 123 that attaches to base piece 121. Although arcuate frame assembly 120 is shown only at the ends of the frame 110, an arcuate frame assembly 120 could be included at one or more intermediate points of the frame 110. In various exemplary embodiments, the segments 122 are connected with a shock-cord 124. This facilitates quick assembly by eliminating the need to identify different segments and/or align them correctly.

FIG. 4 illustrates an exemplary mechanism for connecting arcuate frame segments 122 to assemble the generally arcuate frame section 123. At each connection point, one of the arcuate frame segments 122 comprises a sleeve 125 that is shaped and sized to receive and mate with the adjacent arcuate frame segment 122. It should be noted that the sleeve 125 may be on either arcuate frame segment 122 for any connection and any arcuate frame segment may have two, one, or no sleeves 125. A similar mechanism, without or without a sleeve 125, may be used to connect the ends of the generally arcuate from section 123 to the base 121 to assemble an arcuate frame assembly 120.

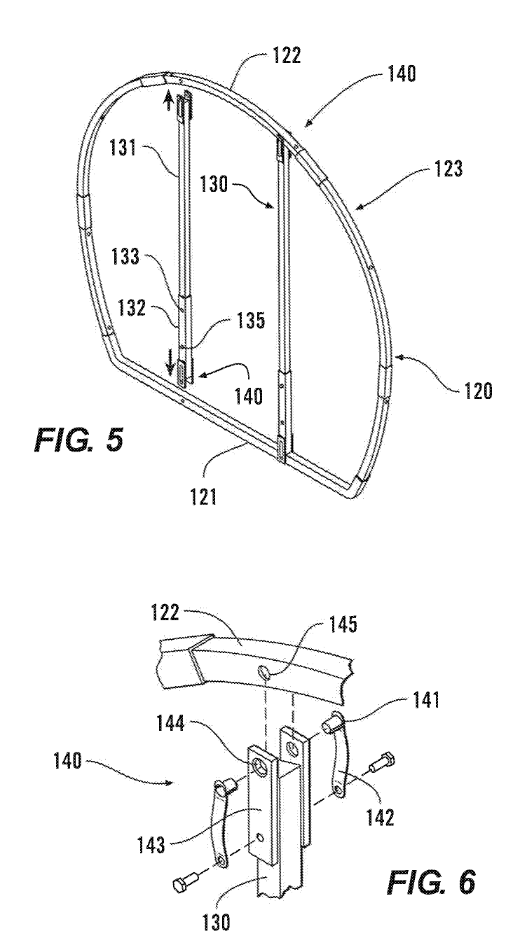

FIG. 5 shows the addition of vertical supports 130 to an end frame assembly 120. In the exemplary embodiment shown in FIG. 5, two vertical supports 120 connect to the arcuate frame assembly 120 at the base piece 121 and at one or more of the arcuate segments 122. In various other exemplary embodiments, a different number of vertical supports 130, including one or none, may be used. In various exemplary embodiments, the vertical supports 130 may comprise a first segment 131 and a second segment 132 that are telescoping for storage with the first segment 131 fitting into the second segment 132 or vice versa. The first segment 131 and second segment 132 are designed to lock into an extended position. In some exemplary embodiments, as shown in FIG. 5, one or more spring-biased knobs (not shown) are supplied in the first segment 131 and lock apertures 134 adapted to fit with the knobs are supplied in the second segment 132. When the knobs are aligned with apertures 133, the knobs are biased into the apertures 133 locking the segments 131 and 132 in place in an extended configuration for use. In various exemplary embodiments, a second pair of apertures 134 may be included in the second segment 132 to lock the segments 131 and 132 in place in a contracted configuration for storage.

FIG. 6 illustrates an exemplary spring-loaded snap button connector assembly 140 for quickly and easily connecting two frame members, e.g., vertical support 130 and arcuate frame segment 122, without tools. The end of a frame component, e.g., vertical support, is equipped with two locking pins 141 on biasing springs 142 and two guides 143 with guide holes 144 aligned with the locking pins 141. Another component, e.g., an arcuate frame segment 122, is equipped with a pair or receiving holes 145 sized to mate with the locking pins 141. The component is placed between the guides 143 such that the guide holes 144 and receiving holes 145 are aligned and the locking pins 141 are allowed to pass through the guide holes 144 into the receiving holes 145 where they are held in place by the biasing springs 142. The components may be quickly and easily disconnected by simply pulling the locking pins 141 out of the receiving holes 145 and separating the components.

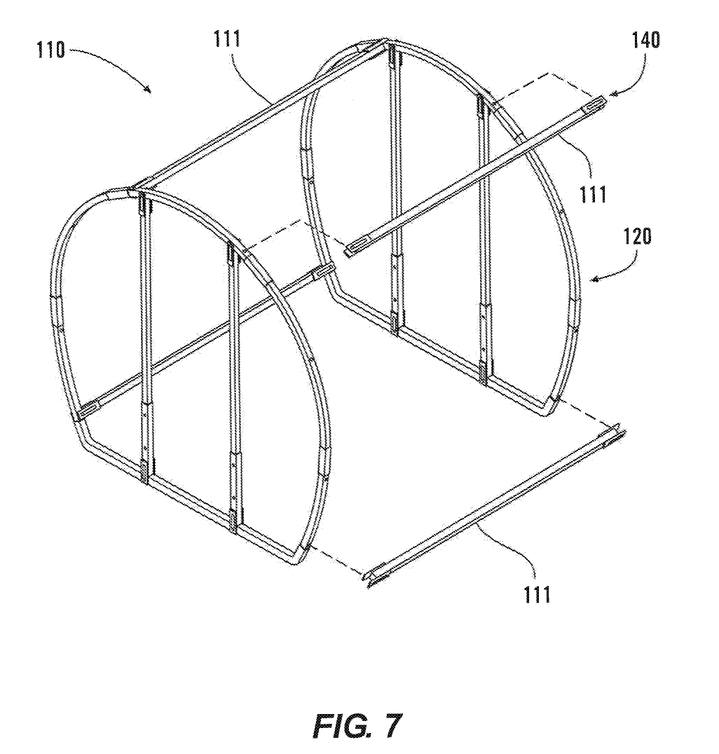

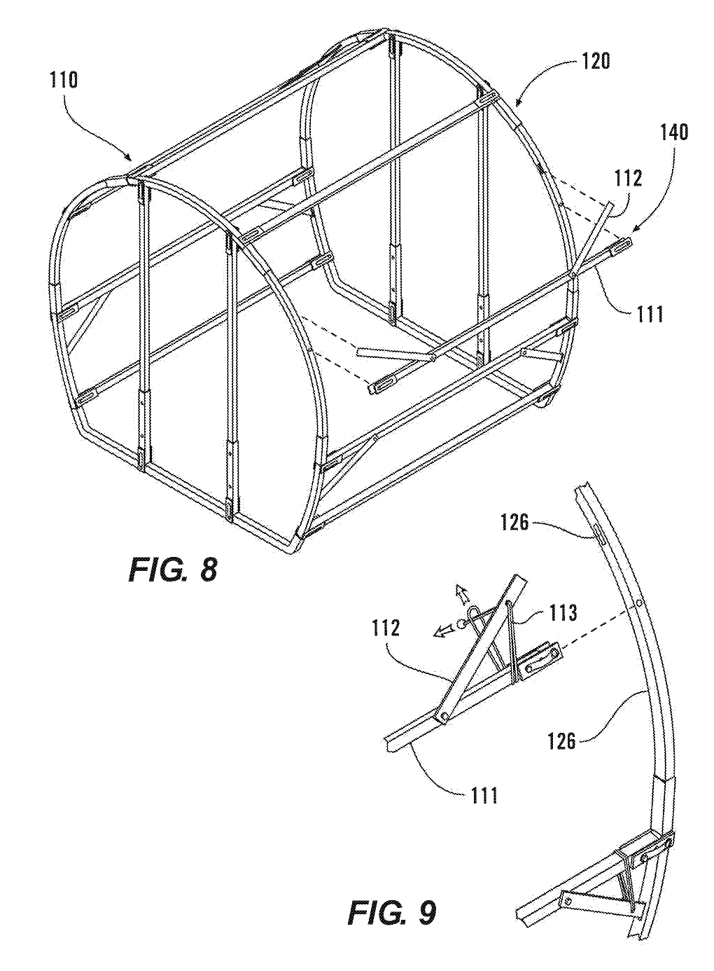

FIG. 7 illustrates the assembly of an exemplary frame 110 having two arcuate frame assemblies 120 connected by a plurality of crossbars 111. In various exemplary embodiments, crossbars 111 are connected to the arcuate frame end assemblies 120 using a mechanism such as shown in FIG. 3. FIGS. 8 and 9 show additional crossbars 111 with reinforcing support bars 112. In various exemplary embodiments, support bars 112 are pivotally connected to the crossbars 111 at one end and adapted for connection to another frame member (e.g., an arcuate frame segment 122) via a slot 126. In various exemplary embodiments, the support bars 112 are held in place by spring or stretchable cord 113. In various other exemplary embodiments, a pin or other mechanism (e.g., a spring-loaded snap button connector) may be used to attach the end of the support bar 112 to another frame member (e.g., an arcuate frame segment 122).

While the frame 110 is shown having eight crossbars 111 somewhat evenly spaced apart, the number and spacing of crossbars 111 may be varied (e.g., more or less for larger or smaller blinds). In various other exemplary, embodiments, the frame may include additional supporting members such as, for example, vertical supports (not shown) located within the interior of the frame attached to crossbars 111 at one end and supported on the ground at the other end.

In various exemplary embodiments, the frame may comprise any generally rigid material that is sufficiently strong to support the weight of the frame and cover, including various metals (e.g., aluminum or steel), plastics or polymers (e.g., polyvinyl chloride), and/or wood. It should be noted that, in some exemplary embodiments, the arcuate frame segments 122 may exhibit some flexibility to bend into the desired shape of the arcuate frame section 123. In various exemplary embodiments, the frame components comprise hollowing tubing with a consistent cross-sectional shape (e.g., round or rectangular), but solid components may be used unless an open space is desired (e.g., where a component fits into another, such as sleeve 125, or to create space for an internal component, such as shock-cord 124).

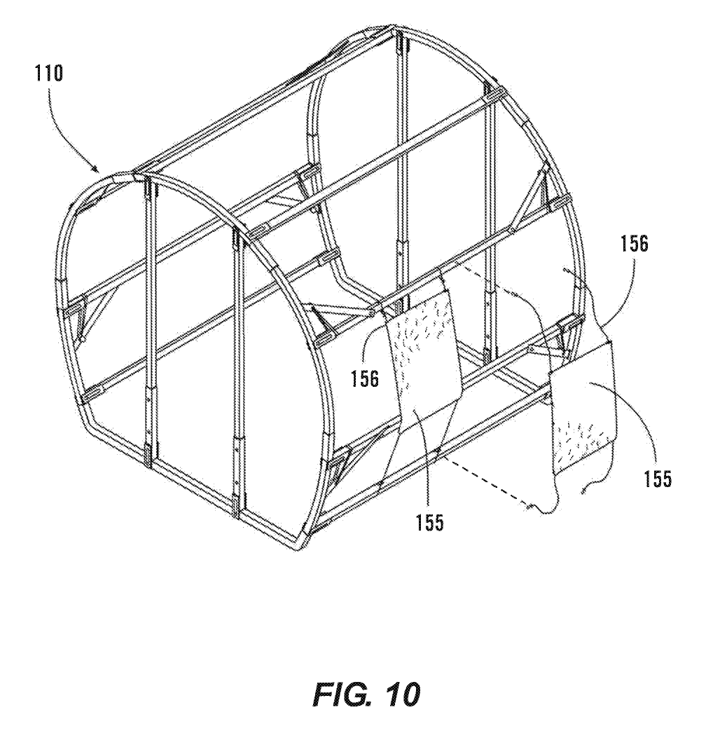

FIG. 10 shows the attachment of two window covers 155 to the frame 110. In various exemplary embodiments, window cover 155 is connected to stretchable, flexible cords 156 (e.g., bungee cords) by passing the cords 156 through opposite side edges of the window cover 155. The ends of the cords 156 are adapted to connect to the crossbars 111 (e.g., by putting a hook on each end or by providing a loop at each end of the cord 156 and attaching it to a knob or other protrusion on the frame 110). In such exemplary embodiments, the window covers 155 may be pushed up or down the cords 156 to block or unblock a window (see FIGS. 1 and 12). In various other exemplary embodiments, the window cover 155 may be attached to the cords in other manners (e.g., a separate cord 156 attached to each corner of the window cover 155). Furthermore, in some exemplary embodiments, the window cover 155 may not be movable relative to the cords 156, but the cords 156 and window covers 156 may be pushed and held aside by an occupant as needed.

In various exemplary embodiments, the bottom of the window is about 36 inches above the ground and is about 14 inches high and 12 inches wide. Although the size of the windows may vary, in general it is preferred that the windows be large enough to provide a good viewing range to the occupant(s), but small enough that little light enters the blind so that the occupant's are not easily seen by nearby animals. Although the windows are shown only on the sides of the hay bale 100, it should be noted that the number and location of windows may be varied (e.g., included on the sides or ends). In various exemplary embodiments, the windows are preferably located at a height that may be conveniently used by a sitting adult.

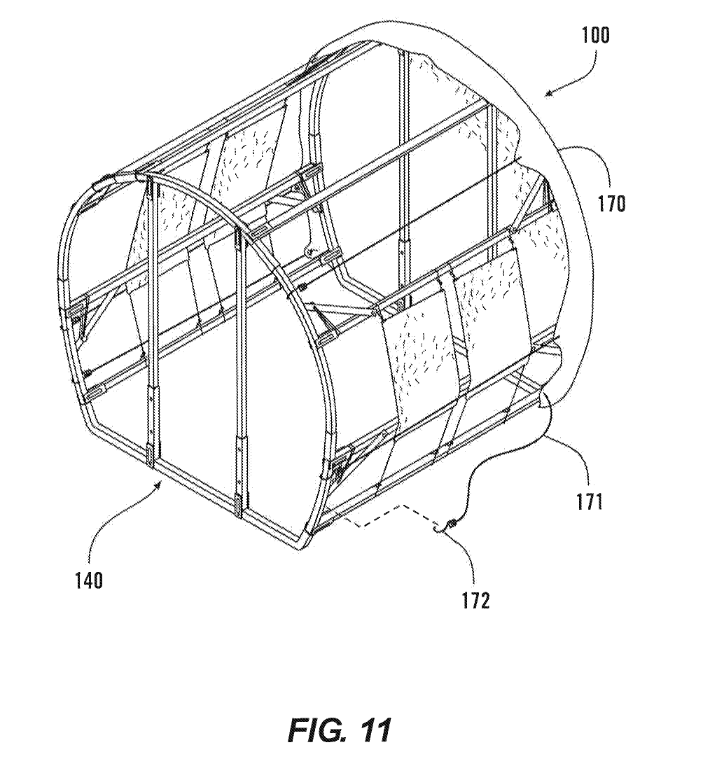

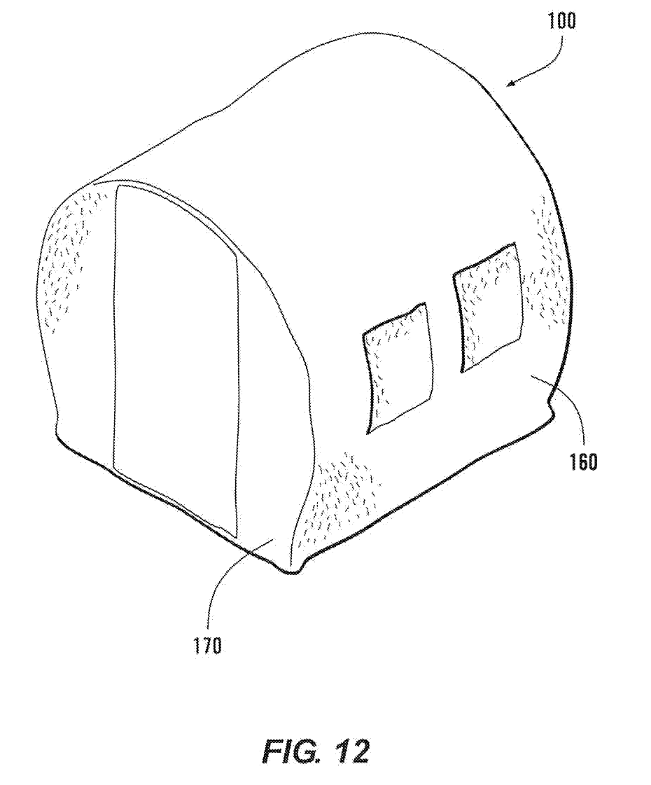

FIG. 11 shows an exemplary end cover 170 being attached to the frame 110. In various exemplary embodiments, the end cover 170 is sized and shaped to cover and fit over the edges of an arcuate frame assembly 120. Stretching cords 171 with fasteners 172 (e.g., hooks) extend from the edge of the end cover 170 and connect to the frame 110 (e.g., to the arcuate frame assembly 120 on the opposite end) and/or another end cover 170. In various exemplary embodiments, the blind 100 is assembled by attaching the first end cover 170 by connecting the fasteners 172 to the frame 110. The second end cover 170 is attached to the frame 100 by disconnecting at least some fasteners 172 from the frame and reattaching them to the second end cover 170. In various exemplary embodiments, some cords 171 are positioned at approximate midpoints between the crossbars 111 to provide additional structural support for the side cover 160 (see FIG. 12) that will go over the crossbars 111. In various exemplary embodiments, one or both end covers 170 may include a door or other opening (not shown) to facilitate ingress and egress. In various other exemplary embodiments, an attached end cover 170 may be pulled aside (e.g., by temporarily disconnecting it from the frame) at an edge to create a temporary opening for ingress and egress.

FIG. 12 shows a fully assembled hay bale blind 100 according to an exemplary embodiment. In various exemplary embodiments, top or side cover 160 is placed over the frame 110 and secured to the bottommost crossbar 111 on each side. If desired, the side cover 160 may be attached to other crossbars 111 for additional stability. These and all other connections in the disclosed hay bale blind 100 are preferentially designed to be connected and disconnected quickly, easily, and without the need for tools (e.g., done by hand alone and preferentially able to be done while wearing gloves in cold weather conditions). In various exemplary embodiments, side cover 160 is secured to the frame 110 at either end to the lowermost crossbars 111 using straps with hook and loop connectors (e.g., Velcro™). In various exemplary embodiments, various other attaching means now known or later developed may be used. In various exemplary embodiments, the top cover 160 may be secured to any or all of the crossbars 111 and/or other frame components.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be appreciated that the construction and arrangement of the portable hay bale blind, as shown in the various exemplary embodiments, is illustrative only. While the portable hay bale blind, according to this invention, has been described in conjunction with the exemplary embodiments outlined above, various alternatives, modifications, variations, improvements, and/or substantial equivalents, whether known or that are or may be presently unforeseen, may become apparent. Accordingly, the exemplary embodiments of the portable hay bale blind, according to this invention, as set forth above, are intended to be illustrative, not limiting. Various changes may be made without departing from the spirit and scope of the invention. Therefore, the description provided above is intended to embrace all known or later-developed alternatives, modifications, variations, improvements, and/or substantial equivalents.

What is claimed is:

1. A portable hay bale hunting blind, comprising:
a frame comprising a plurality of frame members, the frame members comprising:
at least two arcuate frame assemblies, comprising:
a base with a generally flat section; and
a plurality of detachably connectable segments forming a generally arcuate frame detachably connectable to the base; and
a plurality of crossbars detachably connectable to the at least two arcuate frame assemblies;
wherein the crossbars are detachably connectable to the end assemblies at points interspaced along the generally arcuate frame assemblies;
one or more straw covers detachably connectable to the frame, comprising:
a subsurface backing layer;
a fibrous layer attached to the base layer; and
a netting layer overlaying the fibrous layer;
wherein the straw cover is detachably connected to the frame.

2. The portable hay bale hunting blind of claim 1 wherein the one or more straw covers further comprise an erosion control blanket.

3. The portable hay bale hunting blind of claim 1 wherein the generally arcuate assemblies further comprise a plurality of frame members shock-corded together.

4. The portable hay bale hunting blind of claim 1 further comprising telescoping frame members for more compact storage when the hay bale blind is disassembled.

5. The portable hay bale hunting blind of claim 1 wherein at least some connections between frame components are made with spring loaded snap button assemblies.

6. A method for tool-free assembly of a portable hay bale hunting blind, comprising:
assembling a frame with a plurality of detachably connectable frame members, comprising:
a plurality of generally arcuate frame members comprising a plurality of detachably connectable segments; and
one or more crossbars connecting arcuate frame members; and
detachably attaching to the frame one or more straw coverings, comprising:
a subsurface base layer;
a fibrous layer attached to the base layer; and
a netting layer overlaying the fibrous layer.

7. The method of claim 6 wherein the fibrous layer comprises an erosion control blanket.

8. The method of claim 6 further comprising spring loaded snap button assemblies for detachably connecting frame members.

9. The method of claim 6 wherein at least some of the frame members are telescoping for more compact storage when the hay bale blind is disassembled.

10. The method of claim 6 wherein at least some connections between frame components are made with spring loaded snap button assemblies.

11. A hay bale hunting blind, comprising:
a frame comprising:
a generally rectangular base;
two end sections supported by the base and located at a first end and a second end of the base wherein the first end and second end are not adjacent to each other; and
one or more crossbeams extending between the end sections;
a wire grid extending from a first side of the base to a second side of the base in a generally arcuate shape wherein the first side and second side are not adjacent to each other; and
at least one straw covering forming the outer surface of the hunting blind.

12. The hay bale hunting blind of claim 11 wherein the straw covering comprises an erosion control blanket.

13. A method of assembling a hunting blind, comprising:
assembling a frame, comprising:
a generally rectangular frame base;
one or more non-horizontal frame members; and
one or more generally horizontal crossbeams between non-horizontal frame members;
attaching a generally arcuate shaped grid to the frame; and
covering the frame and grid with a straw covering.

14. The method of claim 13 wherein the straw covering comprises an erosion control blanket.

15. The method Of claim 13 wherein the step of covering the frame and grid with a straw covering further comprises:
attaching one or more straw blankets to the grids; and
attaching one or more straw blankets to the grids of the blind.
